(19) United States
(12) Patent Application Publication
(10) Pub. No.: US 2011/0284647 A1
(43) Pub. Date: Nov. 24, 2011

(54) PLANT OF CELLULAR HEATING TO FLOOR

(76) Inventor: Fabrizio Montanari, Castellarano (IT)

(21) Appl. No.: 13/145,947

(22) PCT Filed: Feb. 11, 2010
(86) PCT No.: PCT/IB2010/000258

§ 371 Date: Jul. 22, 2011

(30) Foreign Application Priority Data
Feb. 13, 2009 (IT) MO2009A000034

(51) Int. Cl. F24D 13/02; H05B 3/00

(52) U.S. Cl. 237/69; 219/213

(57) ABSTRACT

An underfloor heating system including some thermal cells provided with an ultrathin heating element located just beneath the floor. The thermal cells are connected as modules when laying the floor. Then they are supplied and handled by a common thermostat (manual or programmable). A floor with even temperature is then obtained, able to transmit radiation heat indoor or outdoor, where installed.

The subject of this invention is an underfloor heating system for indoor use (room heating) as well as for outdoor use, with anti-icing and anti-snow functions. The current technique status offers numberless types of heating systems. All the heating systems with their known qualities and faults will be listed below:
Diesel fuel systems: high fuel cost, average installation costs, big space requirements (tank), polluting combustion, environmental risks for transport, high convenience.
natural gas/LPG systems: average fuel cost, average initial investment, limited space requirements (for natural gas only), big space requirements (for LPG only-tank-), low polluting fuel, environmental risks for transport, high convenience.
Pellet systems: low fuel cost, average installation costs, space requirements for storage, low emissions but only if in good clean conditions and if good quality pellets are used.
Wood gasification systems: low fuel cost, average installation costs, low emissions but only if in good clean conditions, manual feed.
Wood-chip systems: as for wood gasification systems.
Biomass systems: average fuel cost, limited initial investment, no storage requirements, environment-friendly system when the biomass supply is close, average convenience.
Heat pumps with geothermal probes: low fuel cost, high initial investment, environment-friendly system for energy production.
Heat pumps with horizontal surface manifolds: low fuel cost, high initial investment, great space requirement, environment-friendly system.
Air-to-air heat pumps (conditioners): low initial investment, medium-high electric energy consumption, possible creation of moulds and bacteria, low comfort level.
Electric stoves: as for air-to-air heat pumps, with the disadvantage of higher energy consumption.
Radiant plates: low initial investment, average consumption, excellent comfort.

These are generically the types of systems for room heating. It is only necessary to specify that, among the systems using water to circulate heat, there are basically 2 types of solutions: the low efficient central heating system (with radiators) and the much more efficient underfloor system.

The aim of the present invention is to offer a room heating system with a very low initial investment, zero emissions into the environment, zero ordinary maintenance, zero space for housing the above system, low electric energy consumption-high efficiency, therefore with the possibility of self-holding with the help of photovoltaic panels and, as a consequence, eliminate any expense due to private and non-private heating. Besides, differently from other electric systems, bacterial risks are eliminated as no air is moved. This type of system allows the replacement of an old traditional system with radiators without providing for masonry work for the installation of a new system but simply laying a new floor when laying the heating system.

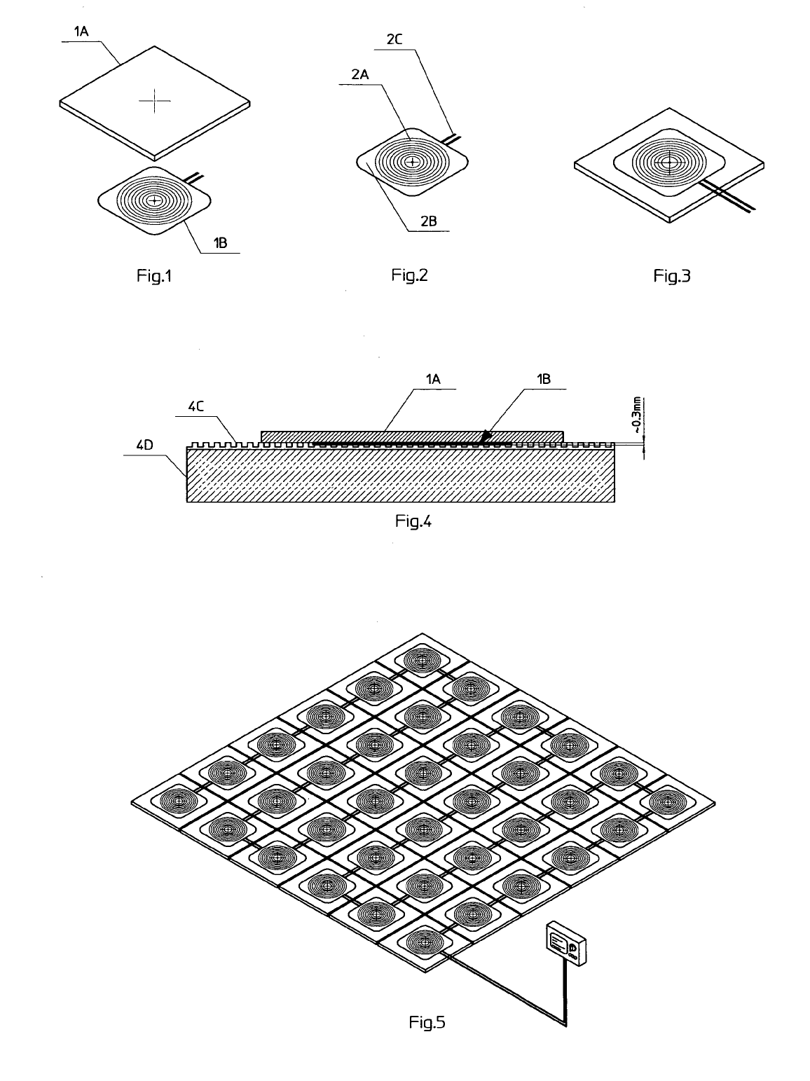

A key solution of this invention is the use of electrical energy for heating even though consumptions are definitely kept low, as this invention does not heat water (very low thermal conductivity coeff.=0.55) but heats directly the rear side of a tile (FIG. 1) with the thermal cell (1B) (therm.cond.coef. of porcelain stoneware=6), and at a limited distance from the room to be heated (few millimeters only), that is the tile thickness only, thus to obtaining high efficiency and low Kw waste.

Each thermal cell (1B) includes a resistance (2A) covered with plastic material layers (2B) which are water- and humidity resistant and low-wear.

The resistance is supplied by conductive elements (2C).

The upper part of the thermal cell (1B) is provided with strong-set adhesive to fully adhere to the rear part of a tile (1A), which becomes a radiator. In this way, the gluing of the cell (1B) to the tile (1A), which acts as a radiator, creates a module; (see FIGS. 1 and 3).

Connecting the modules during laying by means of supply cables (2C), we obtain an underfloor heating system with cells. Each thermal cell (1B) is located between the laying glue (4C) of the floor and the ceramic tile (1A). It is now evident that this invention eliminates the use of housings for thermal cells (1B) (big space requirements), frameworks to support the weight due to walking in the materials that physically protect the thermal cell (1B). Between the single cell (1B), containing the resistance (2A), and the room to be heated, only the tile (1A) is interposed, thus giving a minimum charge loss of the produced heat.

The thermal cell (1B), containing the resistance (2A), forms a unique body with the tile (1A) creating the so called module.

In FIG. 4, the thermal cell (1B) is shown glued to the back of the tile (1A) in a central portion and in direct contact with the tile lower surface where the so called “mark”, which includes the small protrusions on the back of the tiles, is not present. In this way the whole thermal cell (1B), for which the thickness of 0.3 mm (FIG. 4) is indicated, results in practice “built-in” because it does not protrude beyond the mark height. More features of the invention will be pointed out in the following description in the preferred form, but not the only one to be carried out, shown in the enclosed drawings in which:

FIG. 1 shows a perspective exploded view of a module;

FIG. 2 shows a component (thermal cell 1B) of the module in FIG. 1;

FIG. 3 shows an upside-down perspective view of an assembled module;

FIG. 4 shows the cross-section of a floor;

FIG. 5 shows a schematic perspective view of the connection diagram of a plurality of modules.

The enclosed figures show an underfloor heating system which includes a plurality of modules (FIG. 5) which, in their turn, include a plurality of thermal cells (1B).

To summarize, the invention concerns: the installation of a thermal cell or electric resistance on a ceramic tile or building element provided with supply cables which allow the modular connection of the same, thus creating a surface with the said cells homogeneously installed, so as to obtain a floor with even temperature. The resistance element is installed between the laying glue and the ceramic tile (in contact with the tile).

The system must be for indoor use (room heating) as well as for outdoor use, with anti-icing and anti-snow functions or anything else, even supplied by small photovoltaic panels.

It is also possible to replace only one single element of the system, in case of failure of a thermal cell, without big restoration work, masonry expenses, etc. . . .

It is also possible to alternate the operation in predefined areas, thus saving energy.

The resistance element has no other material to heat than the tile between itself and the room: no other building material of any kind is interposed between the two.

To conclude we wish to point out the remarkable saving: consumed energy costs, installation times, labour costs, masonry costs, costs of materials when using this invention, as the tile is produced with said cell built-in and then already has the cell installed during laying. Said cell is a unique body with the same.

As a consequence, when laying the floor, also directly onto an existing floor, without the need for the building operator (layer) to take longer to do his job (connections of the quick connection cell), also the heating system is being installed, thus eliminating the long masonry work and not, as already said, for the installation of a traditional system.

1. Underfloor heating system wherein it comprises a plurality of modules which, in their turn, include a plurality of thermal cells, each one provided with a resistance covered with plastic material layers which are water- and humidity resistant and low-wear;
the thermal cell is glued to the back of the tile in a central portion and in direct contact with the tile lower surface where the so called “mark”, which includes the small protusions on the back of the tiles, is not present; the whole thermal cell, results in tractice “built-in” because it does not protrude beyond the mark height;
said resistance is supplied by conductive elements; the upper part of the cell is provided with strong-set adhesive to fully adhere to the rear part of a tile, which becomes a radiator; in this way, the gluing of the cell to the tile, which acts as a radiator, creates a module;
connection of the modules during laying by means of supply cables, so as to obtain an underfloor beating system with cells.

2. Underfloor heating system as per claim 1, featured by the fact that each thermal cell installed between the floor laying glue and the ceramic tile.

3. Underfloor heating system as per claim 1, featured by the fact that it is possible to alternate the operation in predefined areas, thus saving energy.

4. Underfloor heating system as per claim 2, featured by the fact that, between the single cell, containing the resistance, and the room to be heated, only the tile is interposed.

5. Underfloor heating system as per claim 1, featured by the fact that the thermal cell, containing the resistance, forms a unique body with the tile creating the so called module.

6. Underfloor heating system according to claim 1, featured by the fact that the module thickness (FIG. 3) does not substantially exceed the tile thickness.

7. Underfloor heating system according to claim 1, featured by the fact that the object tile and a group of more tiles become a heating system.
